(19) United States
(12) Patent Application Publication
(10) Pub. No.: US 2015/0146920 A1
(43) Pub. Date: May 28, 2015

(54) GESTURE RECOGNITION METHOD AND APPARATUS UTILIZING ASYNCHRONOUS MULTITHREADED PROCESSING

(71) Applicant: LSI Corporation, San Jose, CA (US)

(72) Inventors: Ivan L. Mazurenko, Moscow (RU); Pavel A. Aliseychik, Moscow (RU); Alexander B. Kholodenko, Moscow (RU); Dmitry N. Babin, Moscow (RU); Denis V. Parfenov, Moscow (RU)

(21) Appl. No.: 14/358,175

(22) PCT Filed: Apr. 18, 2014
(86) PCT No.: PCT/US14/34584

§ 371 Date: May 14, 2014

(30) Foreign Application Priority Data
Oct. 17, 2013 (RU) 2013146467

(51) Int. Cl. G06F 9/52; G06T 1/20; G06K 9/00

(52) U.S. Cl. CPC G06F 9/52; G06K 9/00355; G06T 1/20; G06K 9/00389
USPC 382/103

(57) ABSTRACT

An image processing system comprises an image processor configured to establish a main processing thread and a parallel processing thread for respective portions of a multithreaded gesture recognition process. The parallel processing thread is configured to utilize buffer circuitry of the image processor, such as one or more double buffers of the buffer circuitry, so as to permit the parallel processing thread to run asynchronously to the main processing thread. The parallel processing thread implements one of noise estimation, background estimation and static hand pose recognition for the multithreaded gesture recognition process. Additional processing threads may be established to run in parallel with the main processing thread. For example, the image processor may establish a first parallel processing thread implementing the noise estimation, a second parallel processing thread implementing the background estimation, and a third parallel processing thread implementing the static hand pose recognition.

### FIELD

The field relates generally to image processing, and more particularly to image processing for recognition of gestures.

### BACKGROUND

Image processing is important in a wide variety of different applications, and such processing may involve two-dimensional (2D) images, three-dimensional (3D) images, or combinations of multiple images of different types. For example, a 3D image of a spatial scene may be generated in an image processor using triangulation based on multiple 2D images captured by respective cameras arranged such that each camera has a different view of the scene. Alternatively, a 3D image can be generated directly using a depth imager such as a structured light (SL) camera or a time of flight (ToF) camera. These and other 3D images, which are also referred to herein as depth images, are commonly utilized in machine vision applications, including those involving gesture recognition.

In a typical gesture recognition arrangement, raw image data from an image sensor is usually subject to various preprocessing operations. The preprocessed image data is then subject to additional processing used to recognize gestures in the context of particular gesture recognition applications. Such applications may be implemented, for example, in video gaming systems, kiosks or other systems providing a gesture-based user interface. These other systems include various electronic consumer devices such as laptop computers, tablet computers, desktop computers, mobile phones and television sets.

### SUMMARY

In one embodiment, an image processing system comprises an image processor configured to implement a multithreaded gesture recognition process. The image processor establishes a main processing thread and a parallel processing thread for respective portions of the multithreaded gesture recognition process. The parallel processing thread is configured to utilize buffer circuitry of the image processor, such as one or more double buffers of the buffer circuitry, so as to permit the parallel processing thread to run asynchronously to the main processing thread. The parallel processing thread implements one of noise estimation, background estimation and static hand pose recognition for the multithreaded gesture recognition process.

In some embodiments, additional processing threads may be established to run in parallel with the main processing thread. For example, the image processor may establish a first parallel processing thread implementing the noise estimation, a second parallel processing thread implementing the background estimation, and a third parallel processing thread implementing the static hand pose recognition, each running in parallel to at least a portion of the main processing thread.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an image processing system comprising an image processor implementing an asynchronous multithreaded process for gesture recognition in an illustrative embodiment.

FIG. 2 is a flow diagram of an exemplary asynchronous multithreaded process for gesture recognition implemented in the FIG. 1 system.

### DETAILED DESCRIPTION

Embodiments of the invention will be illustrated herein in conjunction with exemplary image processing systems that include image processors or other types of processing devices and implement techniques for gesture recognition utilizing asynchronous multithreaded processing. It should be understood, however, that embodiments of the invention are more generally applicable to any image processing system or associated device or technique that involves recognizing gestures in one or more images.

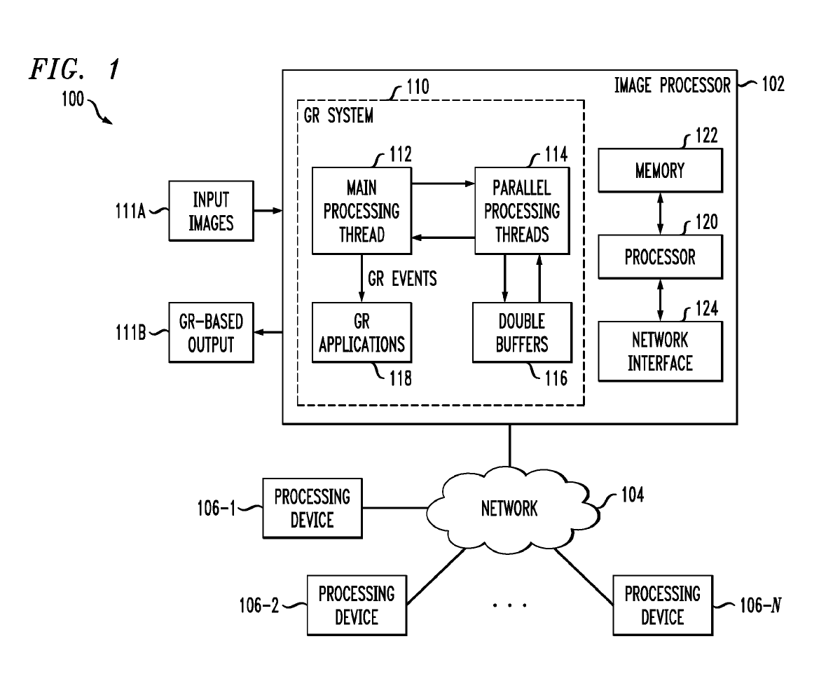

FIG. 1 shows an image processing system 100 in an embodiment of the invention. The image processing system 100 comprises an image processor 102 that is configured for communication over a network 104 with a plurality of processing devices 106-1, 106-2, . . . 106-N. The image processor 102 implements a gesture recognition (GR) system 110. The GR system 110 in this embodiment processes input images 111A from one or more image sources and provides corresponding GR-based output 111B. The GR-based output 111B may be supplied to one or more of the processing devices 106 or to other system components not specifically illustrated in this diagram.

The GR system 110 more particularly comprises a main processing thread 112 that interacts with one or more parallel processing threads 114. Each of the parallel processing threads 114 runs in parallel with at least a portion of the main processing thread 112. One or more of the parallel processing threads 114 are configured to utilize double buffers 116 so as to be able to run asynchronously to the main processing thread. The double buffers 116 may be part of a larger buffer memory or other buffer circuitry of the image processor 102.

Although the main processing thread 112 may also be configured to utilize buffer circuitry of the image processor 102, such buffer circuitry utilized by the main processing thread is not explicitly shown in the figure, and need not comprise double buffers such as those utilized by parallel processing threads 114.

In the present embodiment, the main processing thread 112 and parallel processing threads 114 implement respective portions of a multithreaded gesture recognition process of the image processor 102. By way of example, a given one of the parallel processing threads 114 in the present embodiment implements one of noise estimation, background estimation and static hand pose recognition for the multithreaded gesture recognition process, while the main processing thread 112 implements noise reduction, background removal, hand location detection, hand tracking, dynamic hand parameters estimation, and dynamic hand gesture recognition for the multithreaded gesture recognition process.

As a more particular example, the parallel processing threads 114 comprise a first parallel processing thread implementing the noise estimation, a second parallel processing thread implementing the background estimation, and a third parallel processing thread implementing the static hand pose recognition. The first and second parallel processing threads are illustratively configured to receive input from a common input frame buffer and to provide output to respective noise and background buffers, and the third processing thread is illustratively configured to receive input from a hand parameters buffer and to provide output to a hand pose buffer. Each of these buffers utilized by the first, second and third parallel processing threads may correspond to a respective one of the double buffers 116.

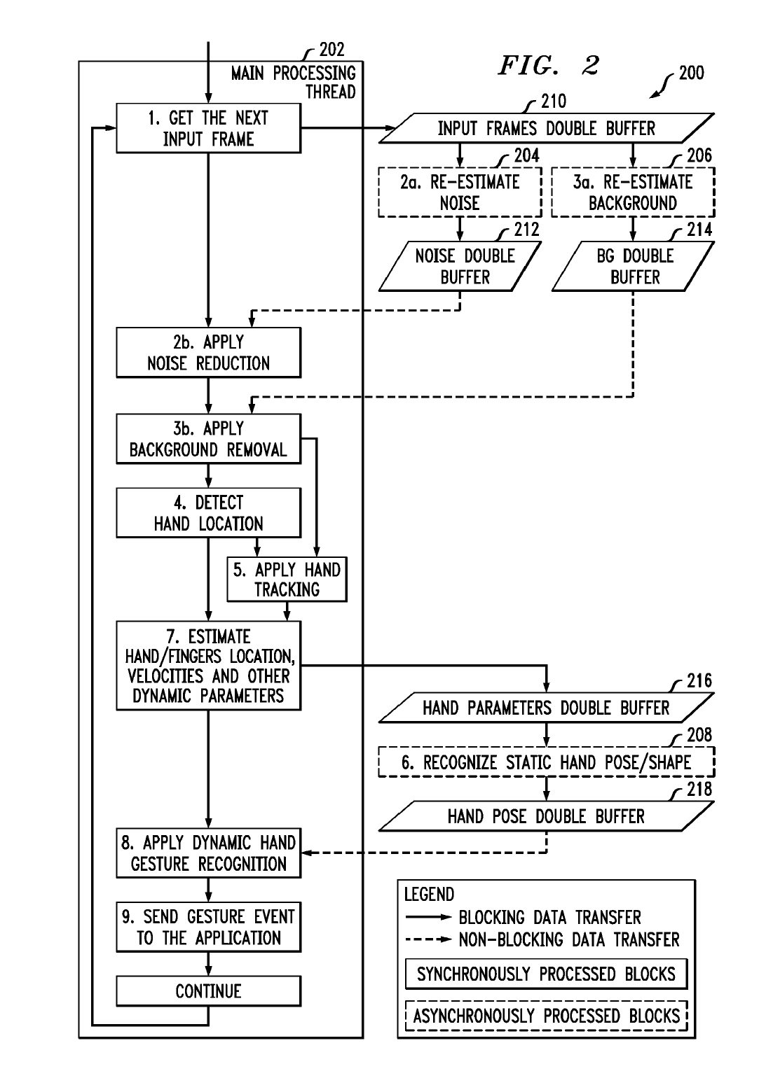

An illustrative arrangement of this type, showing an exemplary main processing thread 112 and its interaction with exemplary first, second and third parallel processing threads 114 utilizing respective exemplary double buffers 116 and providing respective noise estimation, background estimation and static hand pose recognition, will be described in greater detail below in conjunction with FIG. 2. In this embodiment, the first parallel processing thread implementing the noise estimation runs in parallel with a noise reduction portion of the main processing thread, the second parallel processing thread implementing the background estimation runs in parallel with a background removal portion of the main processing thread, and the third parallel processing thread implementing the static hand pose recognition runs in parallel with a dynamic hand parameters portion of the main processing thread.

It is to be appreciated, however, that particular portions of a multithreaded gesture recognition process performed by main and parallel processing threads in these and other embodiments, and the particular manner in which such multiple processing threads are arranged relative to one another, are presented by way of illustrative example only, and other embodiments can utilize a wide variety of other types of multithreaded gesture recognition processes and associated configurations of main and parallel processing threads.

As noted above, one or more of the parallel processing threads 114 run asynchronously to the main processing thread 112. For example, it may be assumed in some embodiments that the main processing thread 112 runs in synchronization with a frame rate of an input image stream comprising input images 111A, and that at least one of the parallel processing threads 114 does not run in synchronization with the frame rate of the input image stream. Thus, one or more of the parallel processing threads 114 may run at a rate that is less than the frame rate of the input image stream.

In the FIG. 1 embodiment, the main processing thread 112 generates GR events for consumption by one or more GR applications 118. For example, the GR events may comprise information indicative of recognition of one or more particular gestures within one or more frames of the input images 111A, such that a given GR application can translate that information into a particular command or set of commands to be executed by that application.

Additionally or alternatively, the GR system 102 may provide GR events or other information, possibly generated by one or more of the GR applications 118, as GR-based output 111B. Such output may be provided to one or more of the processing devices 106. In other embodiments, at least a portion of the GR applications 118 is implemented at least in part on one or more of the processing devices 106.

Portions of the GR system 110 may be implemented using separate processing layers of the image processor 102. These processing layers comprise at least a portion of what is more generally referred to herein as “image processing circuitry” of the image processor 102. For example, the image processor 102 may comprise a preprocessing layer implementing a preprocessing module and a plurality of higher processing layers, at least one of which is configured to implement a main processing thread and one or more additional processing threads running in parallel to the main processing thread, in the manner described previously, for recognition of hand gestures within frames of an input image stream comprising the input images 111A. Such processing layers may also be implemented in the form of respective subsystems of the GR system 110.

It should be noted, however, that embodiments of the invention are not limited to recognition of hand gestures, but can instead be adapted for use in a wide variety of other machine vision applications involving gesture recognition, and may comprise different numbers, types and arrangements of processing threads, operations and layers in other embodiments.

Also, certain processing operations associated with the image processor 102 in the present embodiment may instead be implemented at least in part on other devices in other embodiments. For example, preprocessing operations may be implemented at least in part in an image source comprising a depth imager or other type of imager that provides at least a portion of the input images 111A. It is also possible that one or more of the applications 118 may be implemented on a different processing device than the threads 112 and 114 and the double buffers 116, such as one of the processing devices 106.

Moreover, it is to be appreciated that the image processor 102 may itself comprise multiple distinct processing devices, such that different portions of the GR system 110 are implemented using two or more processing devices. The term “image processor” as used herein is intended to be broadly construed so as to encompass these and other arrangements.

The GR system 110 performs preprocessing operations on received input images 111A from one or more image sources. This received image data in the present embodiment is assumed to comprise raw image data received from a depth sensor, but other types of received image data may be processed in other embodiments. The main processing thread 112 is illustratively configured to operate on such raw image data, and accordingly performs preprocessing operations such as noise reduction and background removal.

The raw image data received by the GR system 110 from the depth sensor may include a stream of frames comprising respective depth images, with each such depth image comprising a plurality of depth image pixels. For example, a given depth image D may be provided to the GR system 110 in the form of matrix of real values. A given such depth image is also referred to herein as a depth map.

A wide variety of other types of images or combinations of multiple images may be used in other embodiments. It should therefore be understood that the term “image” as used herein is intended to be broadly construed.

The image processor 102 may interface with a variety of different image sources and image destinations. For example, the image processor 102 may receive input images 111A from one or more image sources and provide processed images as part of GR-based output 111B to one or more image destinations. At least a subset of such image sources and image destinations may be implemented as least in part utilizing one or more of the processing devices 106. Accordingly, at least a subset of the input images 111A may be provided to the image processor 102 over network 104 for processing from one or more of the processing devices 106. Similarly, processed images or other related GR-based output 111B may be delivered by the image processor 102 over network 104 to one or more of the processing devices 106. Such processing devices may therefore be viewed as examples of image sources or image destinations as those terms are used herein.

A given image source may comprise, for example, a 3D imager such as an SL camera or a ToF camera configured to generate depth images, or a 2D imager configured to generate grayscale images, color images, infrared images or other types of 2D images. It is also possible that a single imager or other image source can provide both a depth image and a corresponding 2D image such as a grayscale image, a color image or an infrared image. For example, certain types of existing 3D cameras are able to produce a depth map of a given scene as well as a 2D image of the same scene. Alternatively, a 3D imager providing a depth map of a given scene can be arranged in proximity to a separate high-resolution video camera or other 2D imager providing a 2D image of substantially the same scene.

Another example of an image source is a storage device or server that provides images to the image processor 102 for processing.

A given image destination may comprise, for example, one or more display screens of a human-machine interface of a computer or mobile phone, or at least one storage device or server that receives processed images from the image processor 102.

It should also be noted that the image processor 102 may be at least partially combined with at least a subset of the one or more image sources and the one or more image destinations on a common processing device. Thus, for example, a given image source and the image processor 102 may be collectively implemented on the same processing device. Similarly, a given image destination and the image processor 102 may be collectively implemented on the same processing device.

In the present embodiment, the image processor 102 is configured to recognize hand gestures, although the disclosed techniques can be adapted in a straightforward manner for use with other types of gesture recognition processes.

As noted above, the input images 111A may comprise respective depth images generated by a depth imager such as an SL camera or a ToF camera. Other types and arrangements of images may be received, processed and generated in other embodiments, including 2D images or combinations of 2D and 3D images.

The particular arrangement of threads, buffers and applications shown in image processor 102 in the FIG. 1 embodiment can be varied in other embodiments. For example, an otherwise conventional image processing integrated circuit or other type of image processing circuitry suitably modified to perform processing operations as disclosed herein may be used to implement at least a portion of one or more of the components 112, 114, 116 and 118 of image processor 102. One possible example of image processing circuitry that may be used in one or more embodiments of the invention is an otherwise conventional graphics processor suitably reconfigured to perform functionality associated with one or more of the components 112, 114, 116 and 118.

The processing devices 106 may comprise, for example, computers, mobile phones, servers or storage devices, in any combination. One or more such devices also may include, for example, display screens or other user interfaces that are utilized to present images generated by the image processor 102. The processing devices 106 may therefore comprise a wide variety of different destination devices that receive processed image streams or other types of GR-based output 111B from the image processor 102 over the network 104, including by way of example at least one server or storage device that receives one or more processed image streams from the image processor 102.

Although shown as being separate from the processing devices 106 in the present embodiment, the image processor 102 may be at least partially combined with one or more of the processing devices 106. Thus, for example, the image processor 102 may be implemented at least in part using a given one of the processing devices 106. By way of example, a computer or mobile phone may be configured to incorporate the image processor 102 and possibly a given image source. Image sources utilized to provide input images 111A in the image processing system 100 may therefore comprise cameras or other imagers associated with a computer, mobile phone or other processing device. As indicated previously, the image processor 102 may be at least partially combined with one or more image sources or image destinations on a common processing device.

The image processor 102 in the present embodiment is assumed to be implemented using at least one processing device and comprises a processor 120 coupled to a memory 122. The processor 120 executes software code stored in the memory 122 in order to control the performance of image processing operations. The image processor 102 also comprises a network interface 124 that supports communication over network 104. The network interface 124 may comprise one or more conventional transceivers. In other embodiments, the image processor 102 need not be configured for communication with other devices over a network, and in such embodiments the network interface 124 may be eliminated.

The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as main and parallel threads 112 and 114 and GR applications 118. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

For example, in some embodiments, the image processing system 100 is implemented as a video gaming system or other type of gesture-based system that processes image streams in order to recognize user gestures. The disclosed techniques can be similarly adapted for use in a wide variety of other systems requiring a gesture-based human-machine interface, and can also be applied to other applications, such as machine vision systems in robotics and other industrial applications that utilize gesture recognition.

Also, as indicated above, embodiments of the invention are not limited to use in recognition of hand gestures, but can be applied to other types of gestures as well. The term “gesture” as used herein is therefore intended to be broadly construed.

The operation of the image processor 102 will be described in greater detail with reference to the flow diagram of FIG. 2. The diagram illustrates an exemplary asynchronous multithreaded gesture recognition process 200 implemented by the GR system 110. Portions of the process 200 are implemented using respective ones of a main processing thread 202 and parallel processing threads 204, 206 and 208. These exemplary main and parallel threads are assumed to correspond to particular instances of respective main and parallel threads 112 and 114 of FIG. 1.

It is further assumed in this embodiment that the input images 111 A received in the image processor 102 from one or more image sources comprise input depth images each referred to as an input frame.

As illustrated in FIG. 2, the processing threads 204, 206 and 208 operate in parallel with portions of main processing thread 202, and utilize double buffers 210, 212, 214, 216 and 218. These double buffers are assumed to comprise respective instances of the double buffers 116 of FIG. 1, and each such double buffer is configured such that data can be written to a first buffer of the double buffer while data is being read from a second buffer of the double buffer and vice versa. The parallel threads 204, 206 and 208 of the gesture recognition process are configured to operate asynchronously relative to the main processing thread 202. As will be described, such an arrangement can provide improved overall gesture recognition performance for a given set of limited processing resources, for example, relative to an arrangement using only a single processing thread comprising a serial arrangement of processing blocks each being run synchronously on a per frame basis.

The multithreaded gesture recognition process illustrated in FIG. 2 includes the following processing blocks:
1. Acquisition of input frames
2. Noise estimation and reduction
3. Background estimation and elimination
4. Hand detection
5. Hand tracking
6. Static hand pose recognition
7. Dynamic hand parameters estimation
8. Dynamic hand gesture recognition
9. Send gesture event to application

It should be understood, however, that other gesture recognition processes in other embodiments may include additional or alternative processing blocks. Accordingly, the particular set of processing blocks listed above and utilized in the FIG. 2 embodiment should be viewed as exemplary only.

In the following description of the FIG. 2 embodiment, the above-listed processing blocks 1 through 9 are also referred to as Block 1, Block 2, . . . Block 9. Blocks 2 and 3 are each separated into two sub-blocks denoted as Blocks 2a and 2b for Block 2 and as Blocks 3a and 3b for Block 3. Solid arrows in the figure denote blocking data transfers between blocks and dashed arrows in the figure denote non-blocking data transfers between blocks. Blocks 2a, 3a and 6 are shown in dashed outline as these blocks are processed asynchronously relative to the main processing thread 202 using the respective parallel processing threads 204, 206 and 208. All other processing blocks are shown in solid outline and are processed synchronously within the main processing thread 202.

The main processing thread 202 is assumed to be synchronized with the frame rate of the input image stream. In other embodiments, this need not be the case. For example, the GR system 110 in some embodiments may have insufficient processing resources to provide processing in synchronization with the input frame rate.

Blocks 2a and 3a implement respective noise estimation and background estimation processes using input data from input frames double buffer 210. These blocks read input data in a non-blocking manner from the double buffer 210 and therefore operate asynchronously and in parallel with the main processing flow. Blocks 2a and 3a in the present embodiment are more particularly denoted as performing “re-estimating” of noise and background, respectively. This is to indicate that these exemplary blocks operate not only on the current input frame, but also utilize stored estimates that were previously generated for one or more previous input frames. Other types of noise estimation and background estimation processes may be used in other embodiments.

Blocks 2a and 3a write output data to the respective noise double buffer 212 and background double buffer 214. This output data is utilized by respective Blocks 2b and 3b which apply noise reduction and background removal, respectively, using noise and background estimates determined asynchronously to the main processing thread by Blocks 2a and 2b.

Similarly, Block 6 implements static hand pose recognition and reads its input data in a non-blocking manner from the hand parameters double buffer 216. It writes its output data to the hand pose double buffer 218. This output data is utilized by the dynamic hand gesture recognition implemented in Block 8. The static hand pose recognition in this embodiment also incorporates shape recognition.

Blocks 2a, 3a and 6 associated with respective parallel processing threads 204, 206 and 208 of the multithreaded gesture recognition process run asynchronously and at a reduced frame rate relative to the main processing thread 202, thereby taking advantage of relatively slow changes in noise parameters, static background parameters and hand pose shape as a function of time as compared to dynamic characteristics of a hand such as hand and finger location, velocity and other dynamic parameters. As indicated above, the use of double buffers allows reading and writing to be made independently in a non-blocking manner. Typically, writing to a given buffer of a double buffer should not be performed substantially less frequently than reading of that buffer. In other embodiments, alternative techniques for providing non-blocking data transfer may be used in place of the double buffers utilized in the present embodiment.

The various processing blocks of FIG. 2 will now be described in greater detail.

Block 1 of the main processing thread 202 is configured to receive input images 111A from an image sensor or other source. As indicated above, this source may comprise a depth imager such as an SL or ToF camera comprising a depth image sensor. Other types of image sensors including, for example, grayscale image sensors, color image sensors or infrared image sensors, may be used. A given image sensor typically provides image data in the form of one or more rectangular matrices of real or integer numbers corresponding to respective input image pixels. These matrices can contain per-pixel information such as depth values and corresponding amplitude or intensity values. Other per-pixel information such as color, phase and validity may additionally or alternatively be provided. The image resolution is given by the dimensions of the one or more rectangular matrices of the input image frames, and may differ for different types of image sources but typically will not differ over time for images from the same source.

As indicated previously, Block 2 is separated into Blocks 2a and 2b. These blocks are used for estimating and reducing the amount of noise in the input data. Any of a wide variety of image noise reduction techniques can be used to implement this block. For example, suitable techniques are described in PCT International Application PCT/US13/56937, filed on Aug. 28, 2013 and entitled “Image Processor With Edge-Preserving Noise Suppression Functionality,” which is commonly assigned herewith and incorporated by reference herein.

Also as indicated previously, Block 3 is separated into Blocks 3a and 3b. These blocks are used for estimating and eliminating from the input frames those pixels corresponding to static or dynamic background. Again, various techniques can be used for this purpose including, for example, techniques described in Russian Patent Application No. 2013135506, filed Jul. 29, 2013 and entitled “Image Processor Configured for Efficient Estimation and Elimination of Background Information in Images,” which is commonly assigned herewith and incorporated by reference herein.

Typically, a given implementation of Blocks 2b and 3b is more complex than that of corresponding Blocks 2a and 3a, which leads to a significant savings in processing resources when Blocks 2b and 3b run asynchronously with a reduced frame rate as in the present embodiment.

The implementation of Block 4 may vary depending on the type of image sensor used. By way of example, for color and infrared image sensors, detection techniques similar to those used in face detection applications may be applied. As another example, for depth image sensors, hand detection may be implemented using a threshold-based technique in which a region of interest (ROI) mask is defined using minimum and maximum distance thresholds and a minimum amplitude threshold, followed by subsequent refinement of the ROI using morphological image operations. A more particular example of such a threshold-based technique is as follows:
1. Set ROIij=0 for each i and j.
2. For each depth pixel dᵢⱼ set ROIᵢⱼ=1 if dᵢⱼ≧dₘᵢₙ and dᵢⱼ≦dₘₐₓ.
3. For each amplitude pixel aᵢⱼ set ROIᵢⱼ=1 if aᵢⱼ>aₘᵢₙ.
4. Coherently apply an “opening” morphological operation to both ROI and its complement to remove dots and holes comprising connected regions of ones and zeros having area less than a minimum threshold area Aₘᵢₙ.

Block 5 is implemented, for example, using motion tracking techniques. In some embodiments, such as those involving high-quality depth image sensors and vertical orientation of the image sensor, the gesture recognition process may omit this block and instead run Block 4 on every input frame.

In one possible implementation, Block 4 is initially used to detect the location of the hand in one or more frames, and for subsequent frames, Block 5 is used instead of Block 4 to track the hand position using hand position information from the previous frame(s). Finally, if motion is detected outside the ROI or the tracked hand is considered lost, the hand detection is again performed using Block 4.

Block 6 is used to recognize a static hand pose observed in a current frame inside a defined ROI. Typically, the GR system 110 is configured to recognize a pre-defined active vocabulary of hand poses and selects between these pre-defined poses during the hand pose recognition portion of the gesture recognition process. Some embodiments may include special “junk” hand pose patterns corresponding to hand poses outside the active GR system vocabulary. Block 6 may be implemented using, for example, classification techniques based on Gaussian Mixture Models (GMMs) or other similar techniques. Additional details regarding techniques that combine image detection and classification and are suitable for use in embodiments of the present invention are disclosed in Russian Patent Application No. 2013134325, filed Jul. 22, 2013 and entitled “Gesture Recognition Method and Apparatus Based on Analysis of Multiple Candidate Boundaries,” which is commonly assigned herewith and incorporated by reference herein.

The implementation of Block 7 may vary depending upon the type of gestures to be recognized by the GR system 110. For example, in an embodiment in which the GR system provides support only for full-hand gestures and does not distinguish individual finger movements, a simple averaging technique may be used to define hand location and associated dynamic parameters. As a more particular example, a center of mass of the palm may be computed in xy or xyz dimensions, depending on image sensor type, and corresponding hand velocities and accelerations may then be estimated using frame timestamps and similar hand location information from previous frames. More complex techniques may be used in some embodiments to track individual fingers in order to provide support for finger gesture recognition.

Block 8 uses information from Blocks 6 and 7 as its inputs and implements detection and recognition of various dynamic gestures supported by the GR system 110. Such dynamic gestures may include, for example, horizontal and vertical swipes. As hand pose shape typically does not change significantly on a frame-by-frame basis, output information from Block 6 is used asynchronously which allows Block 6 to run at a reduced frame rate and in a separate processing thread.

Block 9 completes the synchronous processing of the main processing thread 202 for a given input frame by providing frame-based gesture recognition results to one or more of the higher level GR applications supported by image processor 102. These results are illustratively provided in the form of GR events. The process 200 then returns to Block 1 to repeat the processing for the next input frame. Results provided by Block 9 in a given embodiment may comprise additional or alternative information such as gesture identifiers and estimated gesture parameters. The latter may include, for example, screen cursor coordinates obtained from a detected forefinger position. These and other results generated in the FIG. 2 process may additionally or alternatively comprise part of the GR-based output 111B of the image processor 102.

In the FIG. 2 embodiment, the dynamic hand gesture recognition of Block 8 resides in the main processing thread 202 of the asynchronous multithreaded gesture recognition process 200 and runs on a frame-by-frame basis. This main processing thread is separated from other parallel threads that estimate frame-based parameters such as noise, background and static hand pose. As these separate parallel threads do not need to pass information to the main processing thread on a frame-by-frame basis, they are configured to run asynchronously with the main processing thread at a lower frame rate.

Again, the particular processing blocks, parallel threads, operations and other features of the FIG. 2 embodiment are exemplary only, and numerous alternative arrangements can be used in other embodiments. For example, blocks indicated as being executed serially in the figure can be performed at least in part in parallel with one or more other blocks in other embodiments. The particular processing blocks and their interconnection as illustrated in FIG. 2 should therefore be viewed as one possible arrangement of processing blocks in one embodiment, and other embodiments may include additional or alternative processing blocks arranged in different processing orders.

In these other embodiments, as in the embodiment of FIG. 2, processing resources made available by implementing certain portions a gesture recognition process in respective parallel threads operating at lower frame rates can be used to enhance the performance of a critical task such as dynamic hand gesture recognition in a main processing thread.

Different portions of the GR system 110 can be implemented in software, hardware, firmware or various combinations thereof. For example, software utilizing hardware accelerators may be used for critical processing blocks such as Block 8 while other blocks such as those running in parallel threads are implemented using combinations of hardware and firmware.

At least portions of the GR-based output 111B of GR system 110 may be further processed in the image processor 102, or supplied to another processing device 106 or image destination, as mentioned previously.

It should again be emphasized that the embodiments of the invention as described herein are intended to be illustrative only. For example, other embodiments of the invention can be implemented utilizing a wide variety of different types and arrangements of image processing circuitry, modules, processing blocks and associated operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
establishing a main processing thread and a parallel processing thread for respective portions of a multithreaded gesture recognition process in an image processor; and
configuring the parallel processing thread to utilize buffer circuitry of the image processor so as to permit the parallel processing thread to run asynchronously to the main processing thread;
wherein the parallel processing thread implements one of noise estimation, background estimation and static hand pose recognition for the multithreaded gesture recognition process.

2. The method of claim 1 wherein the main processing thread runs in synchronization with a frame rate of an input image stream and the parallel processing thread does not run in synchronization with the frame rate of the input image stream.

3. The method of claim 2 wherein the parallel processing thread runs at a rate that is less than the frame rate of the input image stream.

4. The method of claim 1 wherein establishing a parallel processing thread comprises establishing a plurality of parallel processing threads, with each of the parallel processing threads being configured to utilize the buffer circuitry of the image processor so as to permit the parallel processing threads to run asynchronously to the main processing thread.

5. The method of claim 4 wherein the parallel processing threads comprise two or more of:
a first parallel processing thread implementing the noise estimation;
a second parallel processing thread implementing the background estimation; and
a third parallel processing thread implementing the static hand pose recognition.

6. The method of claim 5 wherein configuring the parallel processing threads comprises configuring the first and second processing threads to receive input from a common input frame buffer of the buffer circuitry and to provide output to respective noise and background buffers of the buffer circuitry.

7. The method of claim 5 wherein configuring the parallel processing threads comprises configuring the third processing thread to receive input from a hand parameters buffer of the buffer circuitry and to provide output to a hand pose buffer of the buffer circuitry.

8. The method of claim 4 wherein the main processing thread implements at least a subset of noise reduction, background removal, hand location detection, hand tracking, dynamic hand parameters estimation and dynamic hand gesture recognition for the multithreaded gesture recognition process.

9. The method of claim 8 wherein the parallel processing threads comprise two or more of:
a first parallel processing thread implementing the noise estimation and running in parallel with a noise reduction portion of the main processing thread;
a second parallel processing thread implementing the background estimation and running in parallel with a background removal portion of the main processing thread; and
a third parallel processing thread implementing the static hand pose recognition and running in parallel with a dynamic hand parameters portion of the main processing thread.

10. A non-transitory computer-readable storage medium having computer program code embodied therein, wherein the computer program code when executed in the image processor causes the image processor to perform the method of claim 1.

11. An apparatus comprising:
an image processor;
said image processor comprising buffer circuitry;
wherein the image processor is configured to establish a main processing thread and a parallel processing thread for respective portions of a multithreaded gesture recognition process, and to configure the parallel processing thread to utilize the buffer circuitry so as to permit the parallel processing thread to run asynchronously to the main processing thread;
wherein the parallel processing thread implements one of noise estimation, background estimation and static hand pose recognition for the multithreaded gesture recognition process.

12. The apparatus of claim 11 wherein the image processor is configured to establish a plurality of parallel processing threads, with each of the parallel processing threads being configured to utilize the buffer circuitry of the image processor so as to permit the parallel processing threads to run asynchronously to the main processing thread.

13. The apparatus of claim 12 wherein the parallel processing threads comprise two or more of:
a first parallel processing thread implementing the noise estimation;
a second parallel processing thread implementing the background estimation; and
a third parallel processing thread implementing the static hand pose recognition.

14. The apparatus of claim 13 wherein the buffer circuitry comprises:
a common input frame buffer configured to provide input to the first and second processing threads; and
noise and background buffers configured to receive output from respective ones of the first and second processing threads.

15. The apparatus of claim 15 wherein one or more of the common input frame buffer, the noise buffer and the background buffer comprise respective double buffers, with each double buffer configured such that data can be written to a first buffer of the double buffer while data is being read from a second buffer of the double buffer and vice versa.

16. The apparatus of claim 13 wherein the buffer circuitry comprises:
a hand parameters buffer configured to provide input to the third processing thread; and
a hand pose buffer configured to receive output from the third processing thread.

17. The apparatus of claim 16 wherein one or more of the hand parameters buffer and the hand pose buffer comprise respective double buffers, with each double buffer configured such that data can be written to a first buffer of the double buffer while data is being read from a second buffer of the double buffer and vice versa.

18. The apparatus of claim 12 wherein the main processing thread implements at least a subset of noise reduction, background removal, hand location detection, hand tracking, dynamic hand parameters estimation and dynamic hand gesture recognition for the multithreaded gesture recognition process.

19. The apparatus of claim 18 wherein the parallel processing threads comprise two or more of:
a first parallel processing thread implementing the noise estimation and running in parallel with a noise reduction portion of the main processing thread;
a second parallel processing thread implementing the background estimation and running in parallel with a background removal portion of the main processing thread; and
a third parallel processing thread implementing the static hand pose recognition and running in parallel with a dynamic hand parameters portion of the main processing thread.

20. An integrated circuit comprising the apparatus of claim 11.

21. An image processing system comprising the apparatus of claim 11.
